(19) United States
(12) Patent Application Publication
(10) Pub. No.: US 2005/0067807 A1
(43) Pub. Date: Mar. 31, 2005

(54) Wheelchair

(76) Inventors: Michael Harcourt, Calgary (CA); Christian Bagg, Toronto (CA)

Correspondence Address: FLYNN THIEL BOUTELL & TANIS, P.C., 2026 RAMBLING ROAD, KALAMAZOO, MI, 49008-1699, US

(21) Appl. No.: 10/504,227

(22) PCT Filed: Feb. 11, 2003
(86) PCT No.: PCT/CA03/00189

(30) Foreign Application Priority Data
Feb. 11, 2002 (CA) 2,371,409

(51) Int. Cl. B62M 1/14

(52) U.S. Cl. 280/246; 280/250.1

(57) ABSTRACT

A manually-propelled wheelchair having a frame having a forward-facing seat, two independently castered front wheels mounted to the frame, a rear axle suspended beneath the frame, and two rear driving wheels, each rotatably mounted upon an opposite end of the axle. Rotatably mounted upon opposite ends of the axle are two lever arm assemblies, each comprised of a discrete lever arm ending in a handle and extending far enough from the axle to allow an occupant of the seat to grip the handle. A discrete one-way clutch connects the lever arm to the wheel mounted upon the same end of the axle. The one-way clutches may be disconnected by the occupant by operating twist grip handles mounted upon the lever arms. Occupant-operable disk brakes are provided for each driving wheel, a rotor of each disk brake connected to a driving wheel so as to rotate with the driving wheel and a caliper of the disk brake mounted upon a corresponding lever arm.

### FIELD OF THE INVENTION

This invention relates to the field of manually-propelled wheelchairs and in particular to a lever-operated wheelchair.

### BACKGROUND OF THE INVENTION

Manually-propelled wheelchairs are conventionally comprised of a frame having a seat. Typically, the frame is mounted upon two large rear wheels and two small castered front wheels. Many wheelchairs provide grip rings, which are wheel-like structures somewhat smaller than the rear wheels, that are attached outboard of the rear wheels so that an occupant of the seat can apply torque to a rear wheel by gripping the corresponding grip ring and pushing it forward or pulling it back. Further, the occupant may slow or stop the wheelchair by using his or her hands (preferably gloved) to apply friction to the grip rings. The grip rings are advantageous as the occupant's hands can be kept cleaner than if the occupant gripped the rear wheels directly, but the occupant requires considerable upper body strength and coordination to manipulate the wheels using the grip rings. Further, as the movement required to grip and push or pull the grip ring follows a circular arc as the wheel turns, the occupant is restricted to a fairly short stroke unless he or she can bend forward in a somewhat awkward manner to follow that arc.

A large number of other propulsion schemes for manually-propelled wheelchairs have been proposed, but those known to the inventors are either complicated or inefficient or require more strength and coordination than some wheelchair users are capable of providing. In particular, some wheelchair users may lack sufficient strength and coordination in their hands to grip a grip ring, but still have enough strength in their upper arms to push and pull if their movements can be guided in some manner.

### SUMMARY OF THE INVENTION

The present invention is directed in one aspect to providing a manually-propelled wheelchair that includes a frame having a forward-facing seat, two independently-castered front wheels mounted to the frame, and two rear driving wheels rotatably mounted upon opposite ends of a rear axle that is suspended beneath the frame. Two lever arm assemblies, each also rotatably mounted upon an opposite end of the axle, are provided. Each is comprised of a discrete lever arm terminating in a handle and extending far enough from the axle to allow an occupant of the seat to grip the handle and a discrete one-way clutch connecting the lever arm to the wheel mounted upon the same end of the axle. When the occupant pushes the handles in a forward direction, the one-way clutches are engaged so that torque is applied to turn the wheels so as to propel the wheelchair in the forward direction, but when the occupant ceases to push the handles or pulls the handles rearward, the one-way clutches are disengaged, allowing the handles to be pulled freely rearward, and allowing the wheels to rotate forward freely.

In another aspect of the present invention, the lever arm assembly may also include an indexed drive ring fixedly attached to the one-way clutch between the one-way clutch and the lever arm, a retractable drive pin coupled to the lever arm for engaging the indexed drive ring, and an actuator controllable by the occupant for extending and retracting the drive pin. When the pin is retracted, the lever arm is disconnected from the one-way clutch and when the pin is extended to engage the indexed drive ring, the lever arm is connected to the one-way clutch.

In another aspect of the present invention, a discrete occupant-operable disk brake may be included for each wheel. The rotor of the disk brake is connected to the wheel so as to rotate with the wheel. The caliper of the disk brake is mounted upon the lever arm, so that when the lever arm is disconnected from the one-way clutch, the occupant may move a wheel forward or rearward by engaging the brake for that wheel and pushing forward or pulling rearward the handle of that lever arm.

In yet another aspect of the present invention, two guide bars may be fixedly attached to the frame, one upon each side of the frame and parallel to the plane of a wheel. The handle of each lever arm is then slidingly coupled to a discrete one of the guide bars so that the handle is constrained to follow a discrete guide bar as it is pushed or pulled by the occupant.

In yet another aspect of the present invention, the axle is suspended by two elastically yieldable carbon fiber leaves, each of which is only attached at one end thereof to the frame near the front of the frame.

In yet another aspect of the present invention, the caliper of the disk brake is mounted on a bracket connected to the axle tube.

In yet another aspect of the present invention, a multi-speed gear transmission is provided between the lever arm and the one-way clutch mechanism.

### BRIEF DESCRIPTION OF THE DRAWINGS

FIG. 1 is a schematic side elevation view of a first embodiment of a wheelchair embodying the invention.

FIG. 2 is a schematic side elevation view of the wheelchair of FIG. 1 after the removal of the driving wheels.

FIG. 3 is a schematic front elevation view of a portion of the wheelchair of FIG. 1.

FIG. 4 is a schematic exploded front isometric view of the lower end of the lever arm assembly and portions of one driving wheel of the wheelchair of FIG. 1.

FIG. 5 is a fragmentary, partially sectioned, side elevation view of the lower end of the lever arm assembly and portions of one driving wheel of the wheelchair of FIG. 1 viewed facing axial outwardly.

FIG. 6 is a fragmentary, partially sectioned, front elevation view of the lower end of the lever arm assembly and wheel of one driving wheel of the wheelchair of FIG. 1 taken through the axle.

FIG. 7 is a schematic front elevation section of the hub of one driving wheel of the wheelchair of FIG. 1.

FIG. 8 is a right end view of the hub illustrated in FIG. 7.

FIG. 9 is a longitudinal sectional view of the axle stub of one driving wheel of the wheelchair of FIG. 1.

FIGS. 10A, 10B and 10C are fragmentary side elevation, plan, and end views, respectively, of the suspension arm bracket and a portion of one suspension arm of one driving wheel of the wheelchair of FIG. 1.

FIGS. 11A and 11B are fragmentary side elevation and end views of the suspension arm mounting block and portions of one suspension arm and the frame of one driving wheel of the wheelchair of FIG. 1.

FIGS. 12A, 12B and 12C are, respectively, a fragmentary front elevation view and a partial sectional front elevation view of the upper portion of the lever arm assembly of one driving wheel of the wheelchair of FIG. 1 and an isometric view of one of the spacers of those views.

FIG. 13 is a view similar to FIG. 3, but with the caliper of the disk brake being suspended from the axle tube.

FIG. 14 is a cross sectional view similar to FIG. 6, but with a multi-speed planetary gear mechanism arranged between the lever arm and the one-way clutch mechanism and a manually manipulated sun gear selection device associated therewith for effecting a gear change.

FIG. 15 is a side view of a modified wheelchair with the nearest driving wheel removed.

### DETAILED DESCRIPTION

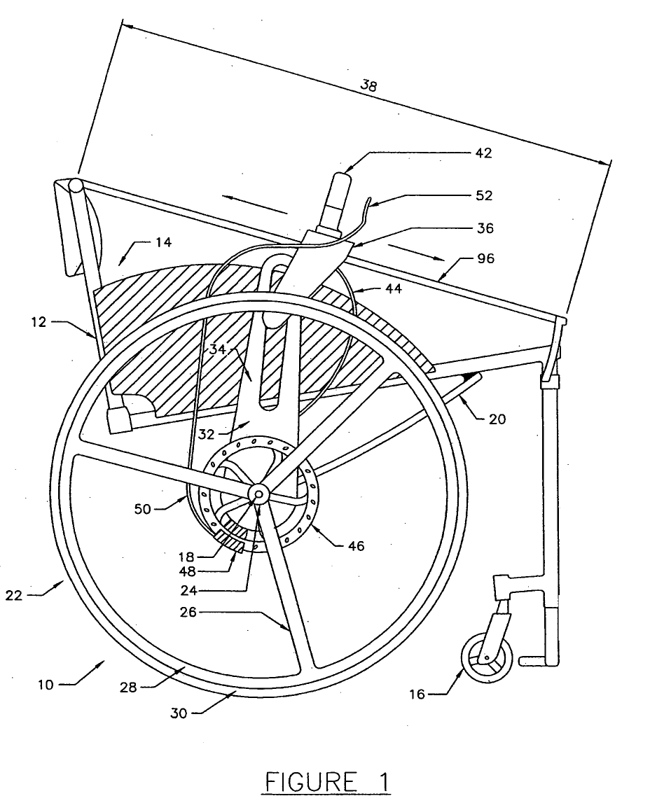

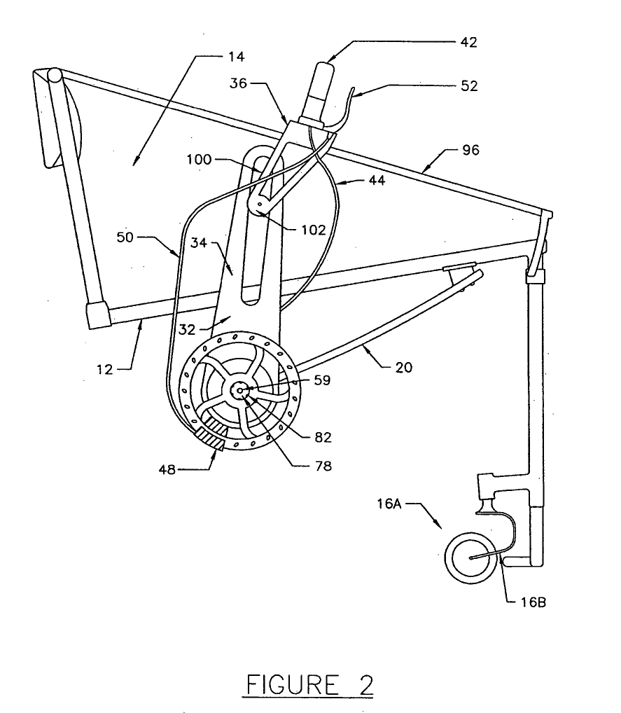

FIG. 1 shows a preferred embodiment of a manually-powered wheelchair in accordance with the present invention. FIG. 2 shows the same embodiment with its driving wheels removed and illustrating alternate castered front wheels 16A that have a resiliently yieldable support 16B connecting the wheels 16A to the chair frame 12. The wheelchair, generally indicated by reference numeral 10 in FIG. 1, comprises a chair frame 12 that includes a forward-facing seat 14 for an occupant, two independently-castered front wheels mounted to the frame 12, the right one of which, from the viewpoint of an occupant of the wheelchair, is visible and is indicated in FIG. 1 by reference numeral 16 or 16A, a rear axle suspended beneath the frame 12, the rear axle including an axle pin 18 that is visible in FIG. 1 and suspended by two suspension arms, the right one of which is indicated by reference numeral 20 in FIG. 1, and two rear driving wheels, the right one of which is visible in FIG. 1 and is indicated generally by reference numeral 22. In the following description, the right driving wheel 22 and the mechanism used to drive and control it will be described in detail. The left driving wheel, which is not shown in FIG. 1, is identical except for the changes necessary to mount it on the left side of the wheelchair 10. Hence all references below are to components on the right side of the wheelchair 10, unless specifically stated to be otherwise. For example, the right driving wheel 22 will henceforth be referred to as “the driving wheel 22”.

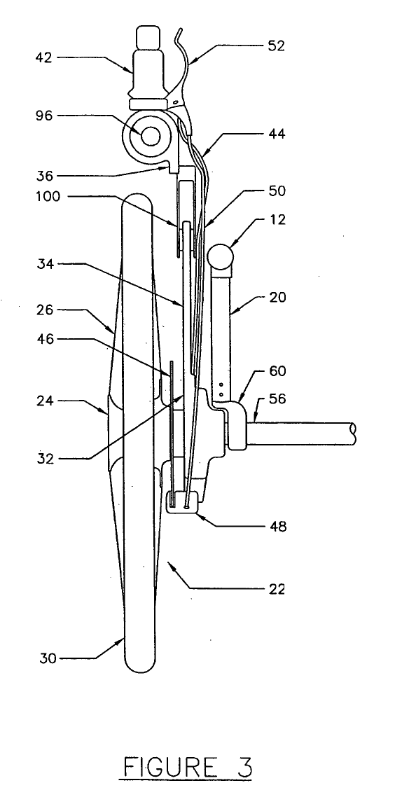

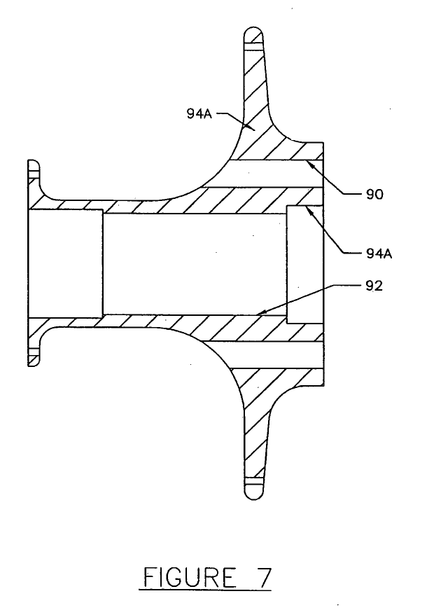

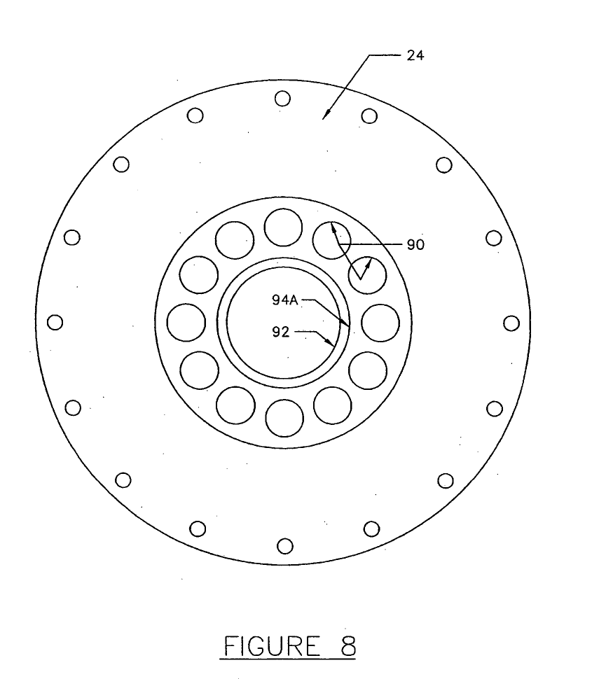

The driving wheel 22, which is shown in more detail in FIG. 3, is conventional, comprising a hub 24, wheel spokes 26, a rim 28, and a tire 30. The hub 24 is shown in detail in FIGS. 7 and 8.

The driving wheel 22 is rotatably mounted upon the axle pin 18 in a manner that will be described in detail below. The foregoing description of the wheelchair 10, with the exception of the suspension arm 20, would generally apply to most wheelchairs currently in use. Such wheelchairs are normally also equipped with grip rings (not shown in the drawings) mounted beside each rear wheel and fixedly connected to the corresponding rear wheel. The occupant can manually grip the grip rings and use them to push the rear wheels forward or backward in order to propel and maneuver the wheelchair as well as to apply braking force to the rear wheels. As discussed above, this arrangement requires considerable strength and coordination in the occupant's hands. Such strength and coordination may be lacking in some wheelchair users even though they may have sufficient upper arm strength to manually propel the wheelchair.

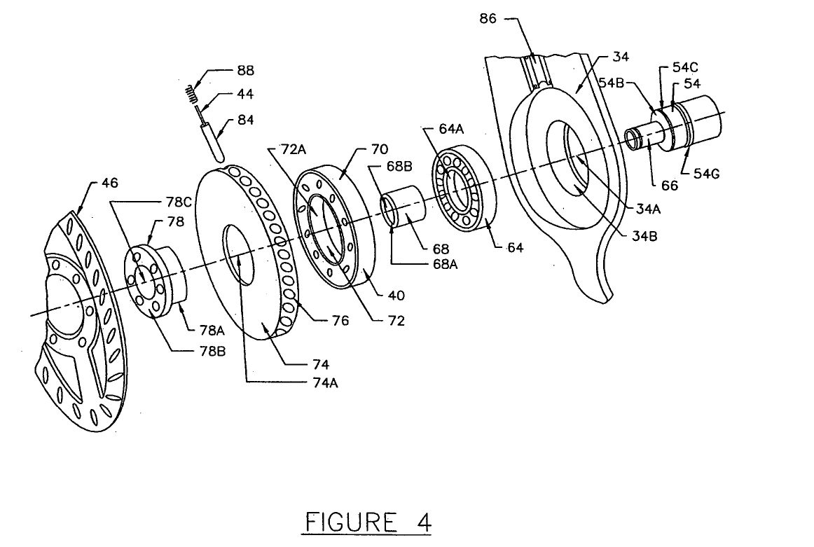

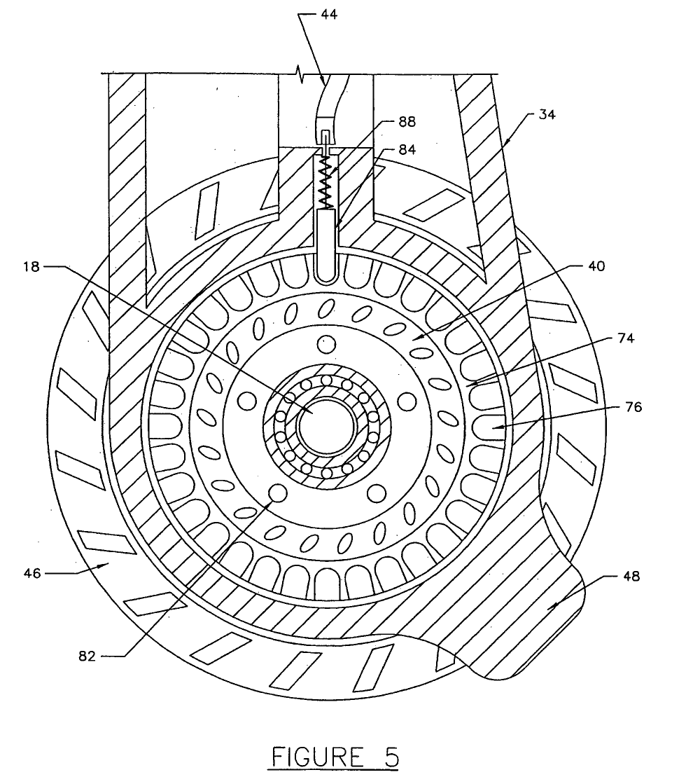

The wheelchair 10, in the place of grip rings uses two lever arm assemblies, one for each driving wheel. Optionally, grip rings (not shown in the drawings) may be retained, if desired, in addition to the lever arm assemblies. The lever arm assembly for the driving wheel 22 is indicated generally by reference numeral 32 in the drawings and is comprised of a lever arm 34, the upper end of which is linked to a handle assembly 36, and a one-way clutch, not visible in FIG. 1, but indicated by reference numeral 40 in FIGS. 4, 5 and 6, for connecting the lever arm 34 to the driving wheel 22. Further details are provided below, but basically the occupant propels the wheelchair 10 forward by pushing the handle assembly 36 forward with sufficient force and speed to engage the one-way clutch 40 and apply a torque to the driving wheel 22. When the occupant stops pushing forward with sufficient force and speed or pulls the handle assembly 36 rearward, then the one-way clutch 40 disengages (because the driving wheel 22 has overrun the clutch 40), allowing the occupant with little effort to return the handle assembly 36 to position it for another forward push. The lever arm assembly 32 extends far enough from the axle pin 18 to allow an occupant of the seat 14 to grip the handle assembly 36 and move it through a range of motion approximately indicted by reference numeral 38 in FIG. 1. Of course, to move straight forward, the occupant must push with relatively equal effort on both the handle assembly 36 and the left handle assembly, which is not shown in the drawings. By applying unequal effort the occupant may turn the wheelchair 10 as it is moving.

The reader will note that the occupant cannot, using the handle assemblies of the wheelchair 10 as described above, rotate a wheel backwards or apply a braking force to a wheel. To provide such capabilities, the wheelchair 10 preferably includes a braking system and a means for bypassing the one-way clutches so that movement of the handle assemblies can drive the wheels in either direction, not just the forward direction. Generally this is accomplished by providing means for disconnecting the lever arms from the one-way clutches and providing brakes mounted on the lever arms so that when the lever arms are disconnected from the one-way clutches and the brakes applied, movement of the lever arms is transmitted to the wheels in a way that is essentially equivalent to the occupant manually gripping the wheels or grip rings and pushing or pulling on the wheels or grip rings directly. In effect, the lever arms and brakes take the place of the occupant's arms and hands, which as will become clear below allows occupants with impaired hand grip strength and control to effectively move about in the wheelchair 10 and also provides more effective use by occupants who have normal arm and hand strength and coordination.

One manner in which the one-way clutches may be made disconnectable by occupant and braking may be applied to the wheels is described in detail below in relation to the right wheel. As discussed above, the description applies equally to the left wheel.

In FIGS. 1, 2 and 3, the handle assembly 36 is shown as including a twist grip 42 of the type conventionally used on bicycles for shifting gears. Details of the twist grip 42 are not shown in the drawings or described further as such mechanisms are conventional and readily available. The twist grip 42 is connected to a grip cable 44 that runs from the handle assembly 36 to the lower end of the lever arm 34. Twisting the grip shift 42 in one direction pulls on the grip cable 44, while twisting it in the other direction releases it. The manner in which this motion is used to connect or disconnect the one-way clutch 40 from the lever arm 34 is described below in detail in relation to FIGS. 4, 5 and 6.

Also shown in FIGS. 1, 2 and 3 is a disk braking system comprised of a rotor 46, a caliper 48, a brake cable 50, and a brake lever 52. These components are readily available conventional bicycle brake components and are also not described in detail. The brake lever 52 is pivotally mounted on the handle assembly 36 in a conventional fashion. The rotor 46 is connected to the rear hub 24 so as to rotate with the rear hub 24 and the caliper 48 is fixedly secured to lower end of the lever arm 34, both in a manner that will be described in detail below in relation to FIGS. 4, 5 and 6.

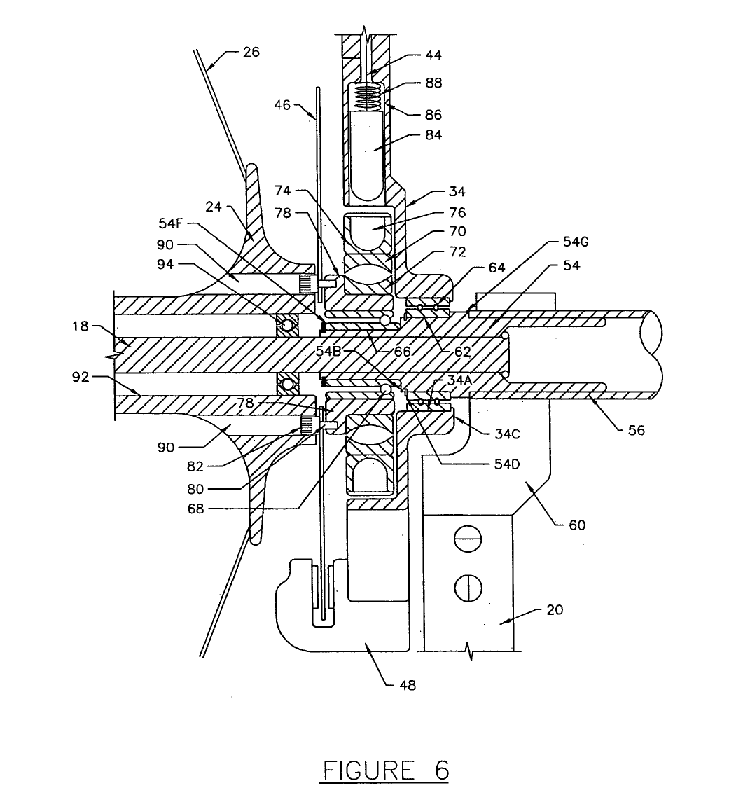

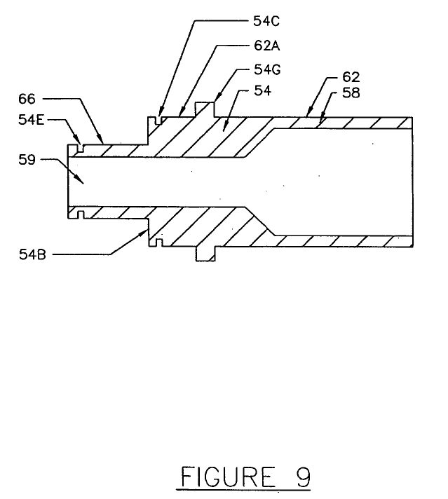

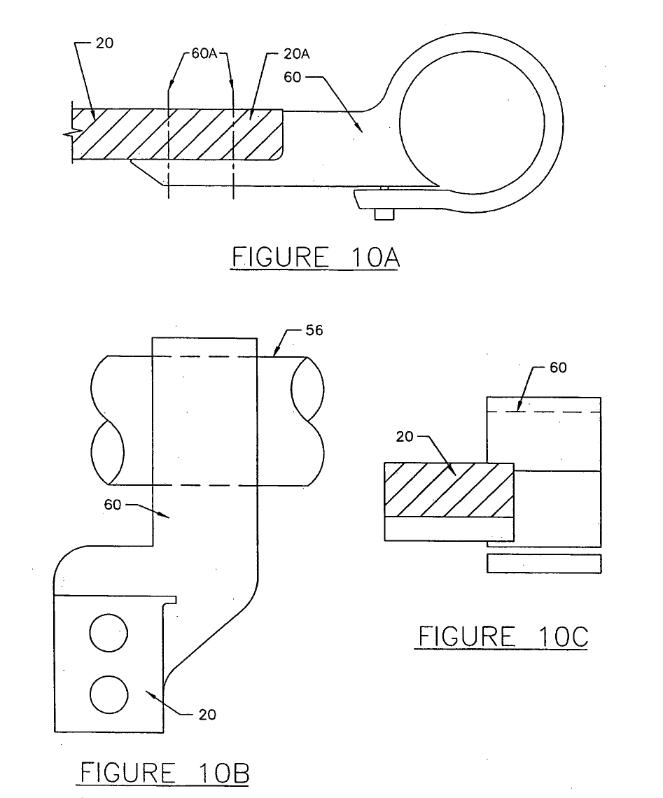

Turning to FIGS. 4, 5 and 6, the rear axle as a whole comprises the axle pin 18, which is a conventional quick release pin, an axle stub 54, an axle tube 56, and the corresponding left axle pin and left axle stub, which are not shown in the drawings. The axle stub 54 is shown in detail in FIG. 9. The axle stub 54 has a first length of a first outer diameter defining a first surface 62 and a second length of a second outer diameter smaller than the first diameter and defining a second surface 66. At the end of the surface 62 immediately adjacent a shoulder 54B extending between the surfaces 62 and 66 there is provided an annular groove 54C configured to receive therein a spring clip 54D (FIG. 6). At the end of the surface 66 remote from the shoulder 54B there is provided a further annular groove 54E configured to receive therein a spring clip 54F (FIG. 6). A radially outwardly extending bead 54G is provided on the surface 62 spaced a defined distance from the groove 54C in a direction away from the shoulder 54B. The axle tube 56 extends between the wheels and is suspended solely by the suspension arm 20 and the left suspension arm (not shown in the drawings). FIGS. 10A-10C show how a suspension arm bracket 60 is used to clamp the suspension arm 20 to axle tube 56. The inside end 58 (right end of FIG. 9) of the axle stub 54 is welded to or press-fitted in place into the outboard end of the axle tube 56. Alternatively, the axle tube and the right and left axle stubs may be machined in one piece. However, using tubular material for the axle tube 56 saves weight. The axle stub 54 has an axial bore 59 for receiving the axle pin 18. As mentioned above, the axle pin 18 is a conventional quick release pin. Starting from the inside end 58 of the axle stub 54, the axle stub 54 is provided with a lever arm bearing mounting surface 62A between the groove 54C and the bead 54G for lever arm bearings 64 that support the lever arm 34 and, between the groove 54E and the shoulder 54B, a one-way clutch bearing mounting surface 66 for one-way clutch bearings 68 that support the one-way clutch 40. That is, the proximal (radially inner) end of the lever arm 34 has a hole 34A therethrough flanked at one end by a radially inwardly extending flange 34C, the surface 34B of the hole receiving therein the bearing 64. A radially inwardly facing surface of a central hole 64A through the bearing 64 is mounted on the surface 62 on the axle stub 54 between and up against the bead 54G and the groove 54C and retained thereat by the spring clip 54D and to facilitate a rotatable support of the lever arm 34 for movement about the axis of rotation of the wheel 22. The bearing 68 has a central hole 68A therethrough and the radially inwardly facing surface 68B mounts onto the bearing mounting surface 66 up against the shoulder 54B as shown in FIG. 6 and is retained thereat by the spring clip 54F.

As shown in FIG. 6, the one-way clutch 40 comprises an outer race 70 and an inner race 72. Fixedly connected to the outer race 70 is a drive ring 74, which is provided with a plurality of radially-outward facing drive ring cavities 76. Fixedly connected to the inner race 72 is a rotor mount 78. That is, the rotor mount 78 includes a hollow sleeve part 78A and an enlarged radially outwardly extending flange 78B at one end of the sleeve. The outer surface of the sleeve part 78A is inserted through a central hole 74A in the drive ring 74 and into the central hole 72A of the inner race 72 of the one-way clutch 40. The hollow interior 78C of the rotor mount 78 receives therein the outer race of the clutch bearing 68. The drive ring 74 has a pocket 74B on one side thereof into which is drivingly fixedly received the outer race 70 of the one-way clutch 40. That is, the inner surface of the inner race 72 is drivingly fixedly supported on the outer surface of the sleeve part 78A and the outer surface of the outer race 70 is drivingly fixedly supported by the radially inwardly facing surface of the pocket 74B. A securement of the sleeve part 78A to the inner race 72 and of the outer race 70 to the surface 74B of the drive ring 74 can be provided by a press fit connection therebetween or a key/slot connection therebetween or by a splined connection therebetween. The rotor 46 is bolted to the flange 78B of the rotor mount 78 with rotor attachment bolts 80 having heads 82 that protrude axially outward.

The grip cable 44 is connected to a drive pin 84 mounted in a radially inwardly directed drive pin cavity 86 near the lower end of the lever arm 34. A spring 88 is provided at the outer end of the cavity 86 to bias the drive pin 84, so that when the grip shift 42 is twisted so as to release tension on the grip cable 44, the drive pin 84 is forced in a radially inward direction, and when the grip shift 42 is twisted so as to pull on the grip cable 44, the drive pin 84 is retracted into the drive pin cavity 86 against the urging of the spring 88.

The lever arm bearing mounting surface 62 is offset axially and radially inward from the drive pin cavity 86 so as to allow the lever arm 34 to be rotatably mounted upon the axle stub 54 by means of the lever arm bearings 64 with the drive pin cavity 86 in the same plane as the drive ring cavities 76. This allows the drive pin 84 to mesh with whichever of the drive ring cavities 76 is aligned with it when the grip shift 42 is twisted so as to release tension on the grip cable 44.

The one-way clutch 40 is rotatably mounted upon the axle stub 54 by means of the one-way clutch bearings 68 mounted as aforesaid on the surface 66. The one-way clutch 40 and the lever arm assembly may rotate independently of each other when the drive pin 84 is retracted.

The hub 24 of the wheel 22 is provided with a plurality of axially extending bores 90 that match the pattern of the rotor attachment bolt heads 82 and a central axial bore 92 in which are mounted hub bearings 94 in a recess 94A provided therefor. The hub 24 is mounted to the lever arm assembly 32 by aligning the axial bores 90 with the rotor attachment bolt heads 82 and inserting the axle pin 18 through the central axial bore 92 until the axle pin 18 locks the hub 24 to the lever arm assembly 32. The axial pin 18 is provided with a conventional release mechanism that need not be described in detail.

When assembled in the manner described above, the wheel 22, the brake rotor 46, the rotor mount 78, and the inner race 72 rotate together on the one-way clutch bearings 68 and hub bearings 94.

If the drive pin 84 is engaged, then the lever arm 34, the drive ring 74, and the outer race 70 rotate together on the lever arm bearings 64. Due to the action of the one-way clutch 40, the lever arm 34 may be pulled backward without appreciable resistance when the wheel 22 is rotating forward. However, if the occupant pushes forward hard enough on the handle assembly 36, the one-way clutch 40 engages to apply a torque to the wheel 22, driving the wheel 22 forward. It should be noted that if the wheel 22 is rotating backward, the lever arm 34 will be moved backward due to the action of the one-way clutch 40.

If the drive pin 84 is retracted, then the handle assembly 36 is disconnected from the one-way clutch 40 and may be pushed forward or pulled backward without applying a torque to the wheel 22 and without appreciable resistance. As well, rotation of the wheel 22 in either direction will not move the lever arm 34.

Since the brake caliper 48 is mounted upon the lever arm 34 rather than upon the frame 12, if braking is applied while the wheelchair 10 is stationary, then the occupant may move the wheel 22 backward by simply continuing to apply the brake while pulling the handle assembly 36 backward. However, to move backward by more than one backward stroke of the handle assembly 36, the one-way clutch 40 must also be disconnected. Otherwise, if the occupant attempts to move the handle assembly 36 forward to prepare for another stroke, the wheel 22 will be moved forward. If the one-way clutch 40 is disconnected, then braking must be applied to move the wheel 22 forward. The result of applying braking with the one-way clutch 40 disconnected is effectively the same as if the occupant gripped the wheel 22 or a grip ring directly with his or her hand and allows similar low-speed maneuverability in restricted spaces.

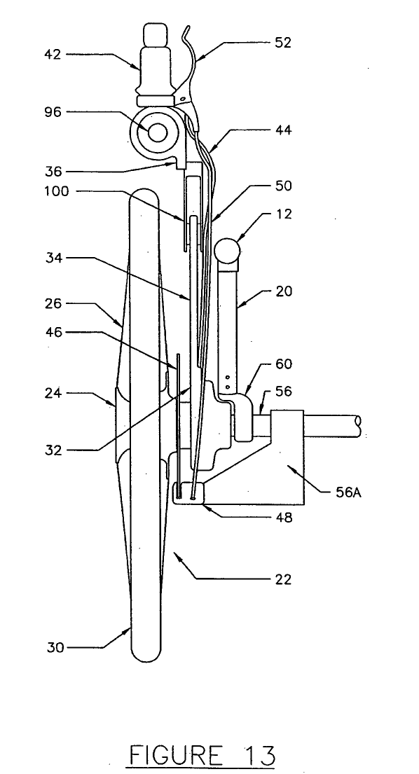

While it is within the scope of this invention to mount the caliper 48 to a frame component, such as the axle tube 56 (FIG. 13) via a bracket assembly 56A, the advantages achieved by the afore-described caliper 48 mounting on the lever arm 34 are not able to be achieved. Instead, the chair occupant must manually grip the hand grip rings provided on the wheel, or at least the wheel directly, in order to effect movement of the chair when the drive pin 84 is disconnected from the one-way clutch.

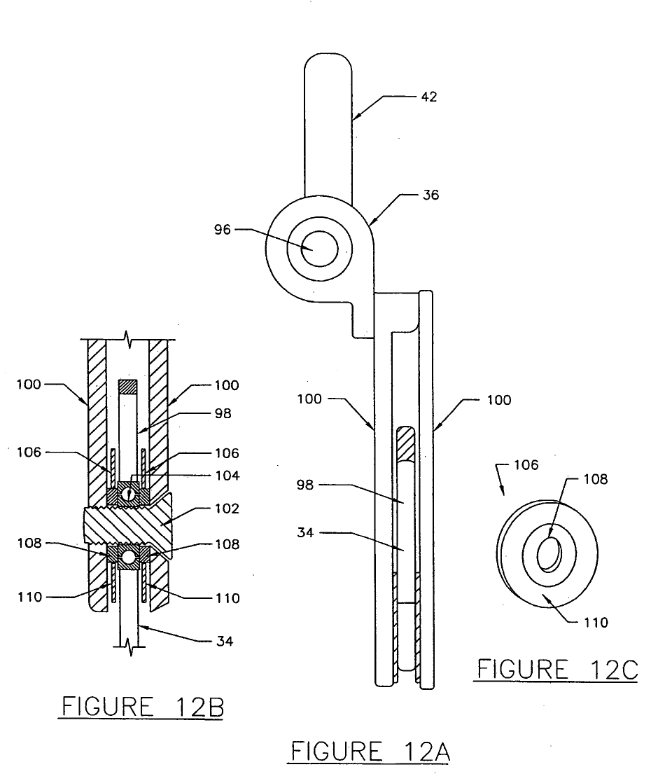

The wheelchair 10 as described above provides no limitation upon how far forward or backward the handle assembly 36 may rotate. This might be acceptable to a strong and coordinated occupant, but could create difficulties for others if the wheelchair 10 were moving rapidly forward and the occupant applied braking too forcefully. In that situation, the handle assembly 36 would be pulled rapidly forward, perhaps causing dire consequences for the occupant. For that reason, it is preferable to provide a guide bar 96 as part of the frame 12. The guide bar 96 runs the length of the frame 12 parallel to the plane of the lever arm 34 and generally above the wheel 22 and sloping downward toward the front of the wheelchair 10. The handle assembly 36 is constrained to follow the guide bar 96 and slides thereon on a linear bearing. Since the motion of the handle is now constrained to be linear and the motion of the lever arm assembly 32 is rotary, a suitable linkage must be provided between the handle assembly 36 and the lever arm assembly 32. As shown in FIG. 2 a slot 98 is provided in the lever arm 34. As shown in more detail in FIGS. 12A, 12B and 12C, the lower end of the handle assembly 36 ends in a two tine fork 100. A bolt 102 passes through one tine of the fork 100, through the slot 98 and is screwed into the other tine. The part of the bolt 102 extending between the tines of the fork 100 supports a bearing 104 in the slot 98 of the lever arm 34. Between each tine and the lever arm 34, a spacer 106 having a brass central section 108 and a Teflon™ outer section 110 is provided.

The length and orientation of the guide bar 96, the slot 98, and the handle assembly 36 are best chosen empirically so that when the bolt 102 is at the top of the slot 98 the handle assembly 36 has traveled to a position near the front or rear end of the guide bar 96 that is comfortable for the occupant. The extreme front and rear positions effectively act as stops to the maximum travel of the handle assembly 36. Providing stops is important in the situation discussed above in which the occupant has applied braking causing the handle assembly 36 to be pulled forward. The occupant can easily apply braking if he or she moves the handle assembly 36 to the extreme forward position and then applies braking. In this situation, the caliper 48 is effectively fixed in position relative to the frame 12, allowing controlled application of braking without the handle assembly 36 being pulled forward as braking is applied. Of course stops could also be attached to the guide bar 96 to directly restrain the movement of the handle assembly 36.

FIG. 1 depicts an alternate handle assembly 36 with only one tine at the lower end. In this instance, the bolt, comparable to the bolt 102 in FIG. 12B, would have a shoulder thereon contacting the tine around the threaded connection and the enlarged head of the bolt would keep the bearing 104 oriented in the slot 98.

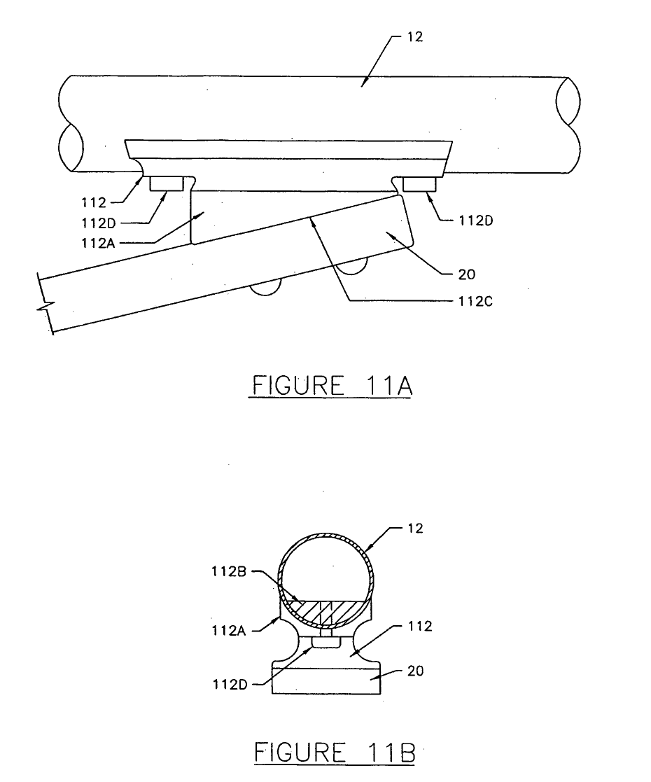

The suspension arm 20 is attached to the frame 12 in the manner shown in FIGS. 11A and 11B by a two part mounting block 112. One end of the suspension arm 20 is secured by fasteners 20A to one part 112A of the two part mounting block 112. In this embodiment, the mounting block 112A has a mounting surface 112C inclined upwardly in a forwardly direction so that a placement of one end of the suspension arm 20 on the mounting surface 112C will cause the suspension arm to be downwardly inclined from the chair frame 12 and toward the rear of the chair whereat the distal end 20A (FIG. 10A) is secured by the bracket 60 by schematically illustrated fasteners 60A and thence to the axle tube 56 as described above and shown in FIGS. 10A-10C.

The chair frame has holes therein at the location whereat the mounting block 112 is to be secured. As shown in FIG. 11B, the second part 112B of the mounting block 112 is oriented inside a tubular section of the chair frame 12. The mounting block part 112B is configured to conform to the interior of the tubular section of the frame 12 and has a pair of tapped holes therein which align with corresponding holes as aforesaid in the frame and in the mounting block part 112A to facilitate threaded fasteners 112D being received therein to fasten the two parts 112A and 112B together and simultaneously effecting a securement of the mounting block parts to the chair frame 12.

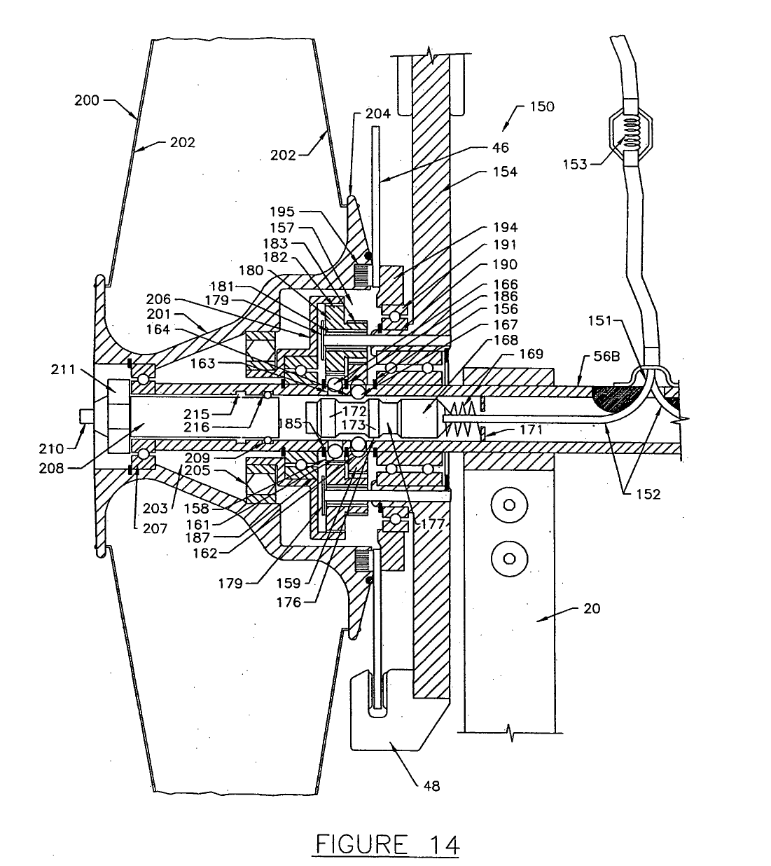

FIG. 14 illustrates an alternate construction of a wheelchair drive arrangement indicated generally by the number 150. More specifically, the axle tube 56B is suspended beneath the frame on the distal ends of the suspension arms 20 in a manner like that which has been described above. However, the axle tube 56B now includes a hole 151 through which extends a pair of cables 152, one for each wheel in this embodiment. The cables 152 include a spring arrangement 153 to facilitate the implementation of a system function by a downward pushing on the cables 152 from above before the system is in a condition for the function to be performed. The system function will be described in more detail below.

In this embodiment, the lever arm 154 (comparable to the lever arm 34 described above) is rotatably supported on the axle tube 56B by a bearing assembly 156 fixedly positioned on the axle tube 56B by conventional spring clips or the like. In addition, a planetary gear arrangement 157 is also mounted on the axle tube 56B. The planetary gear arrangement 157 includes two side-by-side different diameter sun gears 158 and 159 rotatably slidably mounted on the peripheral surface of the axle tube 56B. In this embodiment, the sun gear 159 is larger in diameter than the sun gear 158. Each of the sun gears 158 and 159 have a plurality of ball receiving pockets 161 and 162 provided on the radially inward faces thereof. The axle tube 56B has at least two additional holes 163 and 164 therethrough which are coordinated to align with the pockets 161 and 162, respectively. Balls 166 and 167 are housed in the holes 163 and 164. Inside the axle tube 56B there is provided a spool member 168 supported for reciprocal movement lengthwise of the axle tube 56B. One end (here the right end) of the spool member 168 is connected to a cable 152 and is movable in response to movement of the cable. A spring 169 is provided between an abutment 171 and the spool member to continually urge the spool member 168 to the left. The spool member 168 has a pair of axially spaced raised lands 172 and 173 and a pair of axially spaced grooves 176 and 177. The groove 176 is bordered by the lands 172 and 173 whereas the groove 177 is on a side of the land 173 remote from the groove 176. The axial spacing between the centers of the radially outer surface of the lands is greater than the axial spacing between the centers of the holes 163 and 164. The axial length of the groove 176 is greater than the axial length of the groove 177, the length of the groove 177 being generally equal to a diameter of the ball 167. The axial length of the floor of the groove 176 is less than the axial spacing between the holes 163 and 164. The raised lands 172 and 173 on the spool member 168 are configured to urge a selected ball 166, 167 radially outwardly and into a selected pocket 161, 162 in the selected sun gear 158, 159 to lock the selected sun gear, one at a time, to the axle tube 56B. When the raised land 172 urges the ball 166 into the pocket 161 of the sun gear 159, the ball 167 will be received in the groove 176 to define a first gear position of the spool member 168. When the ball 167 is received in the groove 177, the ball 166 will be received in the groove 176 so that both sun gears 158 and 159 will be unlocked from the axle tube 56B to define a neutral position of the spool member 168. When the ball 167 is urged by the raised land 173 into the pocket 162, the ball 166 will be received in the groove 176 to define a second gear position of the spool member 168.

The peripheral part of each sun gear 158 and 159 is provided with teeth. A plurality of planet gears 180 are supported for rotation on axles 179 fixed to the lever arm 154. The rotatable support of the planet gears is facilitated by bushings or needle bearings 181. In this embodiment, each planet gear 180 has two different diameter side-by-side planet gears 182 and 183 forming a unitary member. The planet gear 182 is larger in diameter than the planet gear 183. The peripheral teeth on the planet gear 182 mesh with the teeth on the sun gear 158 whereas the teeth on the planet gear 183 mesh with the sun gear 159.

The position of two sun gears 158 and 159 on the axle tube 56B is maintained by two axially spaced spring clips 185 and 186. An inner race of a bearing assembly 187 is fixedly positioned on the axle tube 56B next to the sun gear 158.

The lever arm 154 also includes a support surface 190 for an inner race of a bearing assembly 191 maintained thereon between a shoulder and a spring clip. The outer race of the bearing assembly 191 is secured to a ring member 194 having secured thereto the rotor 46 of a disk brake assembly. As has been described above, the rotor 46 is secured to the ring member 194 by plural screws having elongate head extensions 195 thereon. The caliper assembly 48 of the disk brake assembly is fixedly mounted to the lower end of the lever arm 154 and coacts with the rotor 46.

The large diameter driving wheel 200 of the wheelchair includes a hub 201 and wheel spokes 202 extending to a wheel rim on which is provided a tire. The hub 201 has an axially opening pocket 203 opening toward the chair. The pocket opening 203 is encircled by a flange 204 having plural axial openings into each of which is received an elongate extension 195. The interior of the pocket opening 203 includes a one-way clutch 205, the outer race of which is fixedly secured to the hub 201. The inner race of the one-way clutch is fixedly secured to a ring gear component 206 of the afore-described planetary gear arrangement 157. The ring gear 206 includes a surface configured to mount onto the outer race of the bearing assembly 187. The radially inwardly facing teeth of the ring gear 206 mesh with the teeth on each of larger diameter planet gears 182.

The hub 201 also includes a further support fixedly supporting thereon an outer race of a further bearing assembly 207. The inner race rotatably supports a conventional elongate quick release pin 208 having at one end a radially movable ball arrangement 209 and at the other end a push button 210. The left end of the quick release pin 208, adjacent the push button 210, has an enlarged radial flange 211 configured to abut the inner race of the bearing assembly 207.

The axle tube 56B has a pair of axially spaced internal annular grooves 215 and 216 oriented outboard of the hole 163. The groove 216 is configured to receive therein the ball arrangement 209 only when the inner race of the bearing assembly 207 abuts an end face of the axle tube 56B to hold the wheel hub 201 on the axle tube 56B with the holes on the hub receiving therein the elongate head extension 195. The groove 215 serves as a safety feature to receive the ball arrangement 209 therein in case of an inadvertent release of the ball arrangement 209 from an operative connection in the groove 216.

The planetary gear arrangement or system 157 operates as follows. As shown in FIG. 14, the balls 166 and 167 are in the first gear position. The sun gear 158 is locked to the axle tube 56B. Rotation of the lever arm 154 clockwise (top end of lever arm 154 moves toward the viewer) will cause the planets 180 to shift in a clockwise direction and a concurrent rotation in a clockwise direction when viewed from the left side of FIG. 14. This will result in a corresponding clockwise rotation of the ring gear 206 at a first speed. Activation of the cable 152 to urge the spool leftwardly to the second gear position where the sun gear 158 is freed from its connection to the axle tube 56B and the larger diameter sun gear 159 becomes fixed to the axle tube 56B, the smaller diameter planet 183 is rotated faster and consequently the ring gear 206 is rotated faster. In addition, the one-way clutch 205 serves to assure that on each return stroke of the lever arm 154, the wheel will continue to rotate in a clockwise forward traveling direction unobstructed by the return stroke action. It will be recognized that the planetary gear arrangement associated with the other large wheel of the chair will mirror the action described above.

Should the gear shift cable break, the spring 169 will shift the spool member 168 to the neutral position. In the neutral position, the brake calipers 48 can be controlled by the chair occupant as described above.

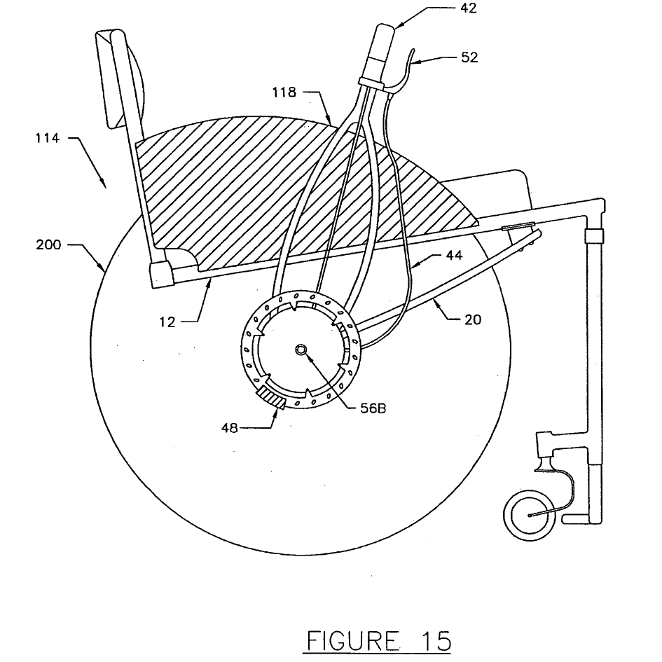

FIG. 15 shows another embodiment of the invention, which is a second wheelchair generally indicated by reference numeral 114 suitable for someone who has good upper body strength and coordination. In this drawing, the nearest driving wheel has been removed and the elements that are shown correspond to elements of the wheelchair 10 shown in FIGS. 1-12 and are labeled with corresponding reference numerals. The primary differences between the two wheelchairs 10, 114 is that the second wheelchair 114 does not include a guide bar corresponding to guide bar 96 and the brake caliper 48 has been moved to the axle tube 56B as shown in FIG. 13. Since there is no longer a guide bar 96, a one-piece lever arm 118 is provided.

The second wheelchair 114 is propelled forward by the same pushing movements, but as the brake caliper 48 is fixed to the axle tube 56B, which is connected to the frame 12, the second wheelchair 114 cannot be moved backward by shifting to neutral so as to disconnect the one-way clutch, engaging the brake and pulling back on the handle 42. Instead, the occupant must shift to neutral, manually grip the wheel 22 or a grip ring, and pull back directly on the wheel 22 or grip ring.

Although particular preferred embodiments of the invention have been disclosed in detail for illustrative purposes, it will be recognized that variations or modifications of the disclosed apparatus, including the re-arrangement of parts, lie within the scope of the present invention.

1. A manually-propelled wheelchair, comprising:
a frame having a forward-facing seat;
two independently castered front wheels mounted to the frame;
a rear axle suspended beneath the frame;
two rear driving wheels, each rotatably mounted upon an opposite end of the axle;
two lever arm assemblies, each rotatably mounted upon an opposite end of the axle for movement about an axis of the axle and each comprised of a discrete lever arm ending in a handle and extending far enough from the axle to allow an occupant of the seat to grip the handle, and a discrete one-way clutch connecting the lever arm to the wheel mounted upon the same end of the axle;
whereby the occupant by pushing the handles in the forward direction with sufficient force may engage the one-way clutches so that torque is applied to turn the driving wheels so as to propel the wheelchair in the forward direction, but when the occupant ceases to push the handles forward or pulls the handles rearward, the one-way clutches disengage, allowing the handles to be pulled freely rearward;
wherein two guide bars are fixedly attached to the frame, one upon each side of the frame and extending parallel to the plane of a respective driving wheel, the handle of each lever arm being slidingly coupled to a discrete one of the guide bars so that the handle is constrained to follow a discrete guide bar as it is pushed or pulled by the occupant; and
wherein the handle and the lever arm are linked by a linkage configured to allow the handle to follow the guide bar while the lever arm moves about an axis of the axle.

2. The manually-propelled wheelchair of claim 1, wherein the lever arm includes a manually operable actuator device configured to selectively disconnect the lever arm from the one-way clutch in response to selective manual operation by the occupant so that the lever arm may be moved forward and rearward without engaging the one-way clutch.

3. The manually-propelled wheelchair of claim 1, wherein the manually operable actuator device includes:
a drive ring with at least one pocket thereon, the drive ring being fixedly attached to the one-way clutch on the input side and drivingly fixed to the rear driving wheel on the output side;
a retractable drive pin on the lever arm configured to be coupled and uncoupled to the pocket on the drive ring; and
an actuator controllable by the occupant for extending and retracting the drive pin into and out of coupling engagement with the pocket on the drive ring;
whereby when the pin is retracted, the lever arm is disconnected from the one-way clutch and when the pin is extended to engage the drive ring, the lever arm is fixedly connected to the one-way clutch.

4. The manually-propelled wheelchair of claim 2, additionally comprising a discrete occupant-operable disk brake for each driving wheel, a rotor of the disk brake being connected to the driving wheel so as to rotate with the driving wheel and a caliper of the disk brake being mounted upon the lever arm, whereby when the lever arm is disconnected from the one-way clutch, the occupant may move a driving wheel forward or rearward by engaging the brake for that driving wheel and pushing forward or pulling rearward the handle of that lever arm.

5. The manually-propelled wheelchair according to claim 1, additionally comprising a discrete occupant-operable disk brake for each driving wheel, a rotor of the disk brake being connected to the driving wheel so as to rotate with the driving wheel and a caliper being mounted upon the frame.

6. The manually-propelled wheelchair according to claim 5, wherein the frame includes the axle and wherein the caliper is mounted upon the axle.

7. The manually-propelled wheelchair of claim 1, wherein the lever arm includes a radially extending slot; and wherein a portion of the handle slides in the slot as the handle is moved forward and rearward.

8. The manually-propelled wheelchair of claim 1, additionally comprising two flexible suspension arms, each attached to the frame near the front of the frame and wherein the axle is suspended solely by the two suspension arms.

9. The manually-propelled wheelchair of claim 8, wherein each of the two flexible suspension arms are made of a carbon fiber composition.

10. The manually-propelled wheelchair according to claim 1, wherein the lever arm includes a multigear arrangement oriented between the lever arm and the one-way clutch.

11. The manually-propelled wheelchair according to claim 10, wherein the multigear arrangement includes a gear selection device to facilitate the driving wheels to be selectively rotatably driven at differing speeds in response to the occupant pushing on the handles.

12. The manually-propelled wheelchair according to claim 11, wherein the multigear arrangement is a planetary gear arrangement having at least one rotatable sun gear, plural planet gears mated with the sun gear and a ring gear mated with each of the planet gears, the sun gear having associated therewith a locking arrangement configured to selectively fix the sun gear so that it will not rotate, the planet gears being each rotatable about axles fixed to the lever arm, the ring gear being coupled to the one-way clutch.

13. The manually-propelled wheelchair according to claim 12, wherein the handle includes a manually operable actuator device configured to selectively fix and unfix the sun gear in response to selective manual operation by the occupant so that the lever arm may be (1) moved forward and rearward, when the sun gear is unfixed, without engaging the one-way clutch and (2) moved forward and rearward, when the sun gear is fixed, to effect engagement of the one-way clutch and a driving of the driving wheels.

14. The manually-propelled wheelchair according to claim 13, wherein the sun gear is mounted for rotation about an axis that is coaxial with the axis of rotation of the driving wheels.

15. The manually-propelled wheelchair according to claim 14, wherein the locking arrangement includes a structure for securing and unsecuring the sun gear to the axle.

16. The manually-propelled wheelchair according to claim 15, wherein the axle is hollow and wherein the locking arrangement structure is oriented inside of the axle.

17. The manually-propelled wheelchair according to claim 16, wherein the sun gear includes at least one radially inwardly opening pocket, and wherein the locking arrangement structure includes at least one member fixed to the axle and configured to move radially inwardly and outwardly in response to operation of the manually operable actuator (1) to be received in the pocket to lock the sun gear to the axle and (2) to be removed from the pocket to unlock the sun gear from the axle.

18. The manually-propelled wheelchair according to claim 17, wherein there are two independently mounted side-by-side sun gears of differing diameter mounted on the axle, each planet gear including two unitary side-by-side gears of differing diameter each mated with a respective one of the sun gears, and one of the two side-by-side planet gears being mated with the ring gear and wherein the manually operable actuator device is configured to select the sun gear to be fixed to the axle.

19. The manually-propelled wheelchair according to claim 1, wherein each driving wheel is mounted to the axle by a quick release pin having radially movable structure operatively engageable with the axle to hold the driving wheels rotatably on the axle while simultaneously preventing relative axial movement therebetween.

20. The manually-propelled wheelchair according to claim 19, wherein the axle has at least two axially spaced structures for separate operative coupling to the radially movable structure, the axially outer one of the two axially spaced structures serving as a backup should there be a failure in the operative coupling of the radially moveable structure with the axially innermost one of the two axially spaced structures.

21. A manually-propelled wheelchair, comprising:
a frame having a forward-facing seat;
two independently castered front wheels mounted to the frame;
a rear axle suspended beneath the frame;
two rear driving wheels, each rotatably mounted upon an opposite end of the axle;
two lever arm assemblies, each rotatably mounted upon an opposite end of the axle and each comprised of a discrete lever arm ending in a handle and extending far enough from the axle to allow an occupant of the seat to grip the handle, and a discrete one-way clutch having an input side and an output side, the one-way clutch drivingly connecting the lever arm to the wheel mounted upon the same end of the axle;
whereby the occupant by pushing the handles in the forward direction with sufficient force may engage the one-way clutches so that torque is applied to turn the driving wheels so as to propel the wheelchair in the forward direction, but when the occupant ceases to push the handles forward or pulls the handles rearward, the one-way clutches disengage, allowing the handles to be pulled freely rearward; and
wherein the lever arm is rotatably mounted on the axle and includes a manually operable actuator device configured to selectively disconnect the lever arm from the one-way clutch in response to selective manual operation by the occupant so that the lever arm may be moved forward and rearward without engaging the one-way clutch.

22. The manually-propelled wheelchair of claim 21, wherein the manually operable actuator device includes:
a drive ring with at least one pocket thereon, the drive ring being fixedly attached to the one-way clutch on the input side and drivingly fixed to the rear driving wheel on the output side;
a retractable drive pin on the lever arm configured to be coupled and uncoupled to the pocket on the drive ring; and
an actuator controllable by the occupant for extending and retracting the drive pin into and out of coupling engagement with the drive ring;
whereby when the pin is retracted, the lever arm is disconnected from the one-way clutch and when the pin is extended to engage the drive ring, the lever arm is fixedly connected to the one-way clutch.

23. The manually-propelled wheelchair of claim 21, additionally comprising a discrete occupant-operable disk brake for each driving wheel, a rotor of the disk brake being connected to the driving wheel so as to rotate with the driving wheel and a caliper of the disk brake being mounted upon the lever arm, whereby when the lever arm is disconnected from the one-way clutch, the occupant may move a driving wheel forward or rearward by engaging the brake for that driving wheel and pushing forward or pulling rearward the handle of that lever arm.

24. The manually-propelled wheelchair according to claim 21, additionally comprising a discrete occupant-operable disk brake for each driving wheel, a rotor of the disk brake being connected to the driving wheel so as to rotate with the driving wheel and a caliper being mounted upon the frame.

25. The manually-propelled wheelchair according to claim 24, wherein the frame includes the axle and wherein the caliper is mounted upon the axle.

26. The manually-propelled wheelchair of claim 21, additionally comprising two guide bars fixedly attached to the frame, one upon each side of the frame and extending parallel to the plane of a respective driving wheel, the handle of each lever arm being slidingly coupled to a discrete one of the guide bars so that the handle is constrained to follow a discrete guide bar as it is pushed or pulled by the occupant.

27. The manually-propelled wheelchair of claim 26, wherein the handle and the lever arm are linked by a linkage configured to allow the handle to follow the guide bar while the lever arm moves about an axis of the axle.

28. The manually-propelled wheelchair of claim 27, wherein the lever arm includes a radially extending slot; and wherein a portion of the handle slides in the slot as the handle is moved forward and rearward.

29. The manually-propelled wheelchair of claim 21, additionally comprising two carbon fiber suspension arms, each attached to the frame near the front of the frame and wherein the axle is suspended solely by the two suspension arms.

30. The manually-propelled wheelchair according to claim 21, wherein the lever arm includes a multigear arrangement oriented between the lever arm and the one-way clutch.

31. The manually-propelled wheelchair according to claim 30, wherein the multigear arrangement includes a gear selection device to facilitate the driving wheels to be selectively rotatably driven at differing speeds in response to the occupant pushing on the handles.

32. The manually-propelled wheelchair according to claim 31, wherein the multigear arrangement is a planetary gear arrangement having at least one rotatable sun gear, plural planet gears mated with the sun gear and a ring gear mated with each of the planet gears, the sun gear having associated therewith a locking arrangement configured to selectively fix the sun gear so that it will not rotate, the planet gears being each rotatable about axles fixed to the lever arm, the ring gear being coupled to the one-way clutch.

33. The manually-propelled wheelchair according to claim 32, wherein the handle includes a manually operable actuator device configured to selectively fix and unfix the sun gear in response to selective manual operation by the occupant so that the lever arm may be (1) moved forward and rearward, when the sun gear is unfixed, without engaging the one-way clutch and (2) moved forward and rearward, when the sun gear is fixed, to effect engagement of the one-way clutch and a driving of the driving wheels.

34. The manually-propelled wheelchair according to claim 33, wherein the sun gear is mounted for rotation about an axis that is coaxial with the axis of rotation of the driving wheels.

35. The manually-propelled wheelchair according to claim 34, wherein the locking arrangement includes a structure for securing and unsecuring the sun gear to the axle.

36. The manually-propelled wheelchair according to claim 35, wherein the axle is hollow and wherein the locking arrangement structure is oriented inside of the axle.

37. The manually-propelled wheelchair according to claim 36, wherein the sun gear includes at least one radially inwardly opening pocket, and wherein the locking arrangement structure includes at least one member fixed to the axle and configured to move radially inwardly and outwardly in response to operation of the manually operable actuator (1) to be received in the pocket to lock the sun gear to the axle and (2) to be removed from the pocket to unlock the sun gear from the axle.

38. The manually-propelled wheelchair according to claim 37, wherein there are two independently mounted side-by-side sun gears of differing diameter mounted on the axle, each planet gear including two unitary side-by-side gears of differing diameter each mated with a respective one of the sun gears, and one of the two side-by-side planet gears being mated with the ring gear and wherein the manually operable actuator device is configured to select the sun gear to be fixed to the axle.

39. The manually-propelled wheelchair according to claim 21, wherein each driving wheel is mounted to the axle by a quick release pin having radially movable structure operatively engageable with the axle to hold the driving wheels rotatably on the axle while simultaneously preventing relative axial movement therebetween.

40. The manually-propelled wheelchair according to claim 39, wherein the axle has at least two axially spaced structures for separate operative coupling to the radially movable structure, the axially outer one of the two axially spaced structures serving as a backup should there be a failure in the operative coupling of the radially moveable structure with the axially innermost one of the two axially spaced structures.

41. A manually-propelled wheelchair, comprising:
a frame having a forward-facing seat;
two independently castered front wheels mounted to the frame;
a rear axle yieldably suspended beneath the frame;
two rear driving wheels, each rotatably mounted upon an opposite end of the axle;
two lever arm assemblies, each rotatably mounted upon an opposite end of the axle for movement about an axis of the axle and each comprised of a discrete lever arm ending in a handle and extending far enough from the axle to allow an occupant of the seat to grip the handle, and a discrete one-way clutch connecting the lever arm to the wheel mounted upon the same end of the axle;
whereby the occupant by pushing the handles in the forward direction with sufficient force may engage the one-way clutches so that torque is applied to turn the driving wheels so as to propel the wheelchair in the forward direction, but when the occupant ceases to push the handles forward or pulls the handles rearward, the one-way clutches disengage, allowing the handles to be pulled freely rearward;
wherein two guide bars are fixedly attached to the frame, one upon each side of the frame and extending parallel to the plane of a respective driving wheel, the handle of each lever arm being slidingly coupled to a discrete one of the guide bars so that the handle is constrained to follow a discrete guide bar as it is pushed or pulled by the occupant; and
wherein the handle and the lever arm are linked by a linkage configured to allow the handle to follow the guide bar while the lever arm moves about an axis of the axle.

42. The manually-propelled wheelchair of claim 41, wherein the lever arm includes a manually operable actuator device configured to selectively disconnect the lever arm from the one-way clutch in response to selective manual operation by the occupant so that the lever arm may be moved forward and rearward without engaging the one-way clutch.

43. The manually-propelled wheelchair of claim 41, wherein the manually operable actuator device includes:
a drive ring with at least one pocket thereon, the drive ring being fixedly attached to the one-way clutch on the input side and drivingly fixed to the rear driving wheel on the output side;
a retractable drive pin on the lever arm configured to be coupled and uncoupled to the pocket on the drive ring; and
an actuator controllable by the occupant for extending and retracting the drive pin into and out of coupling engagement with the drive ring;
whereby when the pin is retracted, the lever arm is disconnected from the one-way clutch and when the pin is extended to engage the drive ring, the lever arm is fixedly connected to the one-way clutch.

44. The manually-propelled wheelchair of claim 42, additionally comprising a discrete occupant-operable disk brake for each driving wheel, a rotor of the disk brake being connected to the driving wheel so as to rotate with the driving wheel and a caliper of the disk brake being mounted upon the lever arm, whereby when the lever arm is disconnected from the one-way clutch, the occupant may move a driving wheel forward or rearward by engaging the brake for that driving wheel and pushing forward or pulling rearward the handle of that lever arm.

45. The manually-propelled wheelchair according to claim 41, additionally comprising a discrete occupant-operable disk brake for each driving wheel, a rotor of the disk brake being connected to the driving wheel so as to rotate with the driving wheel and a caliper being mounted upon the frame.

46. The manually-propelled wheelchair according to claim 45 wherein the frame includes the axle and wherein the caliper is mounted upon the axle.

47. The manually-propelled wheelchair of claim 41, wherein the lever arm includes a radially extending slot; and wherein a portion of the handle slides in the slot as the handle is moved forward and rearward.

48. The manually-propelled wheelchair of claim 41, additionally comprising two flexible suspension arms, each attached to the frame near the front of the frame and wherein the axle is suspended solely by the two suspension arms.

49. The manually-propelled wheelchair of claim 48, wherein each of the two flexible suspension arms are made of a carbon fiber composition.

50. The manually-propelled wheelchair according to claim 41, wherein the lever arm includes a multigear arrangement oriented between the lever arm and the one-way clutch.

51. The manually-propelled wheelchair according to claim 50, wherein the multigear arrangement includes a gear selection device to facilitate the driving wheels to be selectively rotatably driven at differing speeds in response to the occupant pushing on the handles.

52. The manually-propelled wheelchair according to claim 51, wherein the multigear arrangement is a planetary gear arrangement having at least one rotatable sun gear, plural planet gears mated with the sun gear and a ring gear mated with each of the planet gears, the sun gear having associated therewith a locking arrangement configured to selectively fix the sun gear so that it will not rotate, the planet gears being each rotatable about axles fixed to the lever arm, the ring gear being coupled to the one-way clutch.

53. The manually-propelled wheelchair according to claim 52, wherein the handle includes a manually operable actuator device configured to selectively fix and unfix the sun gear in response to selective manual operation by the occupant so that the lever arm may be (1) moved forward and rearward, when the sun gear is unfixed, without engaging the one-way clutch and (2) moved forward and rearward, when the sun gear is fixed, to effect engagement of the one-way clutch and a driving of the driving wheels.

54. The manually-propelled wheelchair according to claim 53, wherein the sun gear is mounted for rotation about an axis that is coaxial with the axis of rotation of the driving wheels.

55. The manually-propelled wheelchair according to claim 54, wherein the locking arrangement includes a structure for securing and unsecuring the sun gear to the axle.

56. The manually-propelled wheelchair according to claim 55, wherein the axle is hollow and wherein the locking arrangement structure is oriented inside of the axle.

57. The manually-propelled wheelchair according to claim 56, wherein the sun gear includes at least one radially inwardly opening pocket, and wherein the locking arrangement structure includes at least one member fixed to the axle and configured to move radially inwardly and outwardly in response to operation of the manually operable actuator (1) to be received in the pocket to lock the sun gear to the axle and (2) to be removed from the pocket to unlock the sun gear from the axle.

58. The manually-propelled wheelchair according to claim 57, wherein there are two independently mounted side-by-side sun gears of differing diameter mounted on the axle, each planet gear including two unitary side-by-side gears of differing diameter each mated with a respective one of the sun gears, and one of the two side-by-side planet gears being mated with the ring gear and wherein the manually operable actuator device is configured to select the sun gear to be fixed to the axle.

59. The manually-propelled wheelchair according to claim 58, wherein each driving wheel is mounted to the axle by a quick release pin having radially movable structure operatively engageable with the axle to hold the driving wheels rotatably on the axle while simultaneously preventing relative axial movement therebetween.

60. The manually-propelled wheelchair according to claim 59, wherein the axle has at least two axially spaced structures for separate operative coupling to the radially movable structure, the axially outer one of the two axially spaced structures serving as a backup should there be a failure in the operative coupling of the radially moveable structure with the axially innermost one of the two axially spaced structures.

61. A wheelchair, comprising:
a frame having a forward-facing seat;
two independently castered front wheels mounted to the frame;
a rear axle;
two rear driving wheels, each rotatably mounted upon an opposite end of the axle;
two flexible suspension arms configured to support the chair occupant when seated, one end of each thereof being attached to the frame near the front of the frame; and
wherein the axle is secured to and is suspended solely by the two suspension arms.

62. The wheelchair according to claim 61, wherein each of the two flexible suspension arms are made of a carbon fiber composition.

63. The wheelchair according to claim 61, wherein each of the two independently castered front wheels include a yieldable suspension configured to support the chair occupant when seated.
